(19) United States
(12) Patent Application Publication
(10) Pub. No.: US 2020/0028689 A1
(43) Pub. Date: Jan. 23, 2020

(54) LOCATION-BASED AND TIME-BASED PHOTO AUTHENTICATION

(71) Applicant: CA, Inc., New York, NY (US)

(72) Inventors: Lyju Rappai VADASSERY, Mumbai (IN); Vijay Shashikant KULKARNI, Bangalore (IN); Vikrant NANDAKUMAR, Bangalore (IN)

(73) Assignee: CA, Inc.

(21) Appl. No.: 16/143,073

(22) Filed: Sep. 26, 2018

(30) Foreign Application Priority Data
Jul. 18, 2018 (IN) 201811026785

(51) Int. Cl. H04L 9/32; H04L 29/06; G06F 17/30

(52) U.S. Cl. CPC H04L 9/3242; H04L 9/3228; G06F 17/3033; H04L 63/08

(57) ABSTRACT

A method is described for receiving a first request for authentication from a user, the first request including a current location, a current location keyword, a current timestamp, and a photo representing the current location. The method further includes generating a pHash of the photo representing the current location, transmitting a second request for an encrypted true index from a server, and receiving the encrypted true index from the server. The method further includes interrogating a plurality of pHashes to identify a true pHash that corresponds to the encrypted true index, where the plurality of pHashes includes the true pHash and a plurality of dummy pHashes, each of the plurality of dummy pHashes being associated with a respective dummy index. The method further includes comparing the pHash of the photo representing the current location with the true pHash to determine whether to authenticate the user.

### CROSS-REFERENCE TO RELATED APPLICATION

This application claims priority to Indian Patent Application No. 201811026785, filed Jul. 18, 2018, the entire subject matter and disclosure of which is incorporated herein by reference.

### BACKGROUND

The present disclosure relates generally to authentication, and more specifically to a location-based and time-based photo authentication.

### SUMMARY

A method is described for receiving a first request for authentication from a user, the first request including a current location, a current location keyword, a current timestamp, and a photo representing the current location. The method further includes generating a pHash of the photo representing the current location, transmitting a second request for an encrypted true index from a server, and receiving the encrypted true index from the server. The method further includes interrogating a plurality of pHashes to identify a true pHash that corresponds to the encrypted true index, where the plurality of pHashes includes the true pHash and a plurality of dummy pHashes, each of the plurality of dummy pHashes being associated with a respective dummy index. The method further includes comparing the pHash of the photo representing the current location with the true pHash to determine whether to authenticate the user.

### BRIEF DESCRIPTION OF THE DRAWINGS

Aspects of the present disclosure are illustrated by way of example and are not limited by the accompanying drawings.

FIG. 1A illustrates an authentication system in a non-limiting embodiment of the present disclosure.

FIG. 1B illustrates the systems of an authentication system in a non-limiting embodiment of the present disclosure.

FIG. 2 is a flowchart of operations and information flows for user location creation in a non-limiting embodiment of the present disclosure.

FIG. 3 is a flowchart of operations and information flows for user authentication of a non-limiting embodiment of the present disclosure.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The present disclosure describes an authentication system that performs authentication based on a location, time, and/or photo. More particularly, the present disclosure describes an authentication system that validates that a user is at a particular location, within a particular time range, based on a photo that may be known only to the user and may be taken by the user at the location. The authentication system, in a non-limiting embodiment of the present disclosure, may provide additional authentication security by segregating the information necessary to authenticate a user and encrypting any information stored locally. In certain embodiments, this process of authentication may provide advantages in lowering the risk of intrusion by entities intercepting messages from the application 106 and the authentication server 102, since some of the information necessary to authenticate a user may not be transmitted between the application 106 and the authentication server 102.

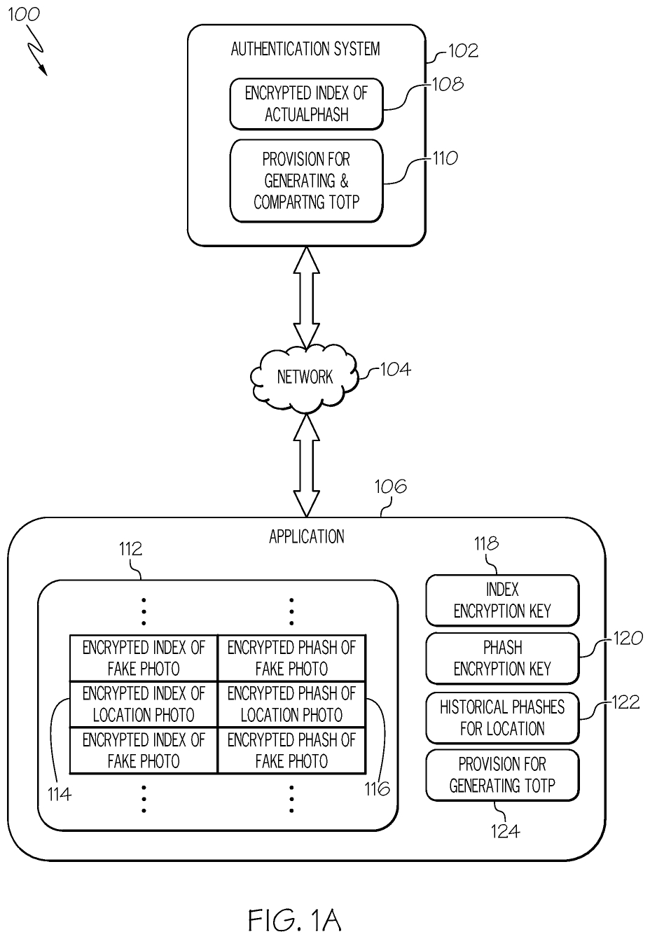

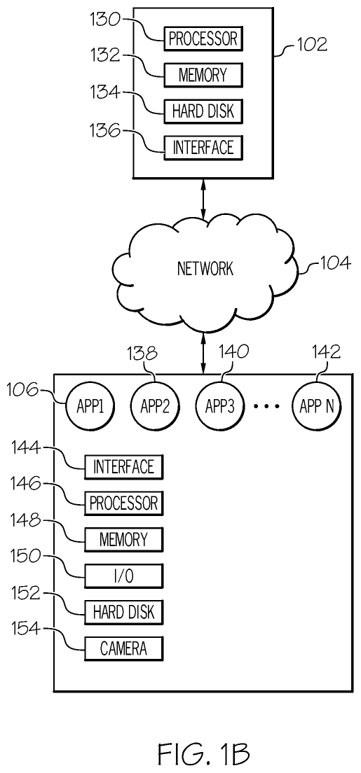

FIG. 1A illustrates an authentication system 100 in a non-limiting embodiment of the present disclosure. The authentication system 100 may include an authentication server 102, a network 104, and an application 106. In some embodiments, the authentication server 102 may be combined with the application 106.

The authentication server 102 may be located on the cloud, on an external network, or on an internal network. In some non-limiting embodiments, the authentication server 102 may be partially located on a local device and partially on the cloud or a network, or any combination thereof. Furthermore, some non-limiting configurations of the authentication server 102 may be located exclusively on the same device as the application 106. The authentication server 102 may be accessed by the application 106 either directly, or through a series of systems configured to facilitate authentication requests to be passed to and from the authentication server 102. In some embodiments, the authentication server 102 may be already configured to handle user login and secured communication protocols between the application 106 and the authentication server 102. In some embodiments, the secure communication protocol implemented by the authentication server 102 may be a public key infrastructure (“PKI”) system, where the PKI maintains roles, policies, and procedures needed to create, manage, distribute, use, store, and revoke digital certificates and manage public key encryption.

Network 104 may comprise one or more entities, which may be public, private, or community based. Network 104 may permit the exchange of information and services among users/entities that are connected to such network 104. In certain configurations, network 104 may be a local area network, such as an intranet. Further, network 104 may be a closed and/or private network/cloud in certain configurations, and an open network/cloud in other configurations. Network 104 may facilitate wired or wireless communications of information and provisioning of services among users that are connected to network 104.

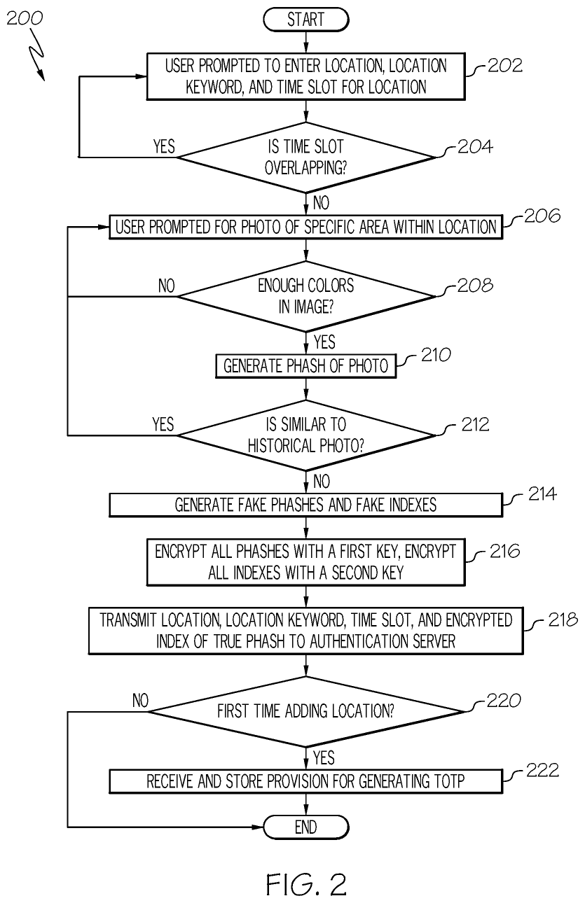

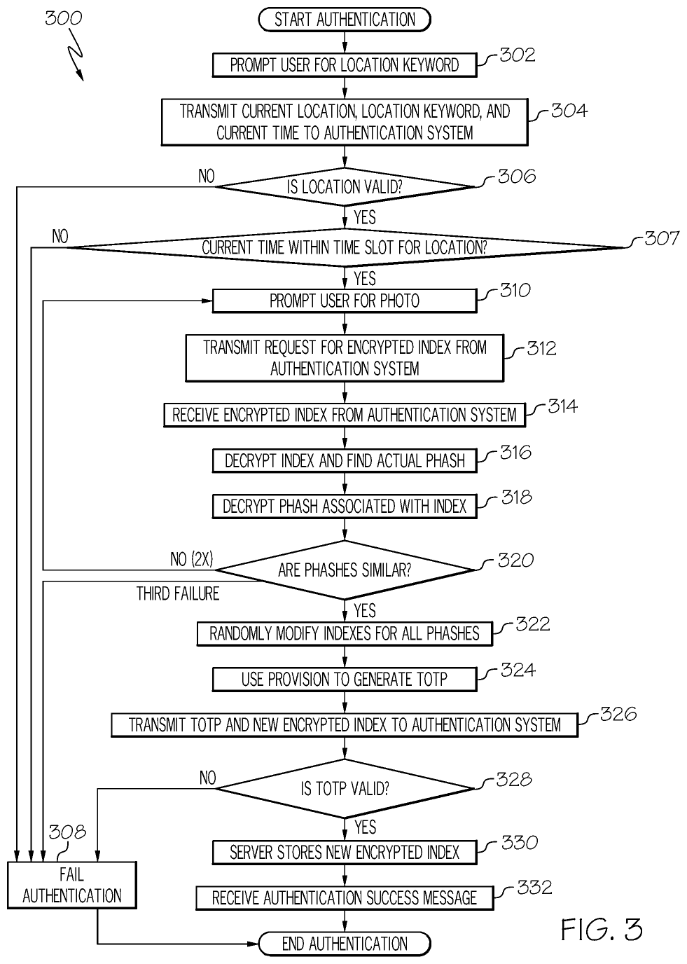

The application 106 of the authentication system 100 may be connected to the authentication server 102 through the network 104. The application 106 may support user authentication, in conjunction with the authentication server 102, by providing a mechanism for location and time-based authentication using photos. The operation of the application 106 is further described in FIG. 2 and FIG. 3.

FIG. 1B illustrates the systems of an authentication system in a non-limiting embodiment of the present disclosure. The systems of the authentication system 100 may include an authentication server 102, a network 104, and an application 106. The authentication server 102 may include a processor 130, volatile memory 132, a hard disk or other non-volatile storage 134, and an interface 136. The authentication server 102 may be connected to the application 106 through a network 104. The system hosting the application 106 may be a mobile device, a computer, or any other system that can host the application 106. The system hosting the application 106 may include a plurality of other applications 138-142, an interface 144, a processor 146, volatile memory 148, input/output devices 150, hard disk or non-volatile storage 152, and a camera 154.

FIG. 2 is a flowchart of operations and information flows for user location creation in a non-limiting embodiment of the present disclosure. The user location creation 200 flowchart describes the way a user may be able to create a verified location associated with the user, where the created verified location can later be used to reliably authenticate a user. The user location creation 200 may be used one or many times by the user. The user location creation 200 may be conducted in the application 106 or the authentication server 102. The user location creation 200 may be used before, after, concurrently with, or independent of the user authentication depicted in FIG. 3.

The user location creation 200 may begin with step 202 where the user is prompted to enter a location, a location keyword, and a time slot for the location. In a non-limiting embodiment of the present disclosure, the location may be a way to identify the precise location of any place that the user chooses. In some embodiments, the location may take the form of GPS coordinates. In these embodiments, the location in the form of GPS coordinates may additionally define a range, where the range defines how close a GPS coordinate must be to the location's GPS coordinates in order to constitute a match. In some embodiments, the location may take on other forms like a street address. In order to authenticate with the authentication system 100, the user may need to be present at the place identified by the location.

In a non-limiting embodiment of the present disclosure, the location keyword is associated with the location, and may represent any place that the user chooses. In some embodiments, the location keyword may identify common places where the user visits (e.g., office, user's home, school). In some embodiments, the location keyword may identify a particular place with another place (e.g., the kitchen of the user's home, the bedroom of the user's home, a specific office within an office building, a particular classroom within a school). In some embodiments, the location keyword may be unique, where a single location is associated with a single location keyword.

In step 202, the user may also be prompted to enter a time slot for the location and location keyword. The time slot for the location may represent the time period during which the location is valid for user authentication. The time slot for the location may consist of a beginning time and an ending time. For example, in a non-limiting embodiment of the present disclosure, the user may choose a time slot of 9 am to 5 pm for the location “office,” where the user may only be able to use the authentication system 100 for authentication when the user is located at the office between 9 am and 5 pm.

After receiving the location, location keyword, and location time slot, the authentication system 100, in step 204, may determine if the location time slot is overlapping with another time slot. In some embodiments, the determination of step 204 occurs within the application 106. The location time slot being added may be compared with previously added time slots to allow a maximum of one location to be valid at any given point in time. An advantage of not allowing overlapping time slots may be to provide additional security during authentication and reduce the risk of unauthorized authentication. In some embodiments, in step 204, the application 106 may also determine if the location or location keyword overlap with previously entered locations or location keywords. If the application 106 determines that the time slot is overlapping with another time slot, the user is returned to step 202 to re-enter the location, location keyword, and location time slot.

If the application 106 determines, in step 204, that the location time slot does not overlap with previous time slots, the user is prompted, in step 206, to submit a photo of a specific area within the location. The photo of the location, in step 206, may be a currently taken photo. In some embodiments, the location photo may be restricted to only a currently taken photo (e.g., a timestamp or other proof that the photo was taken within the previous few minutes). In another embodiment, the photo may be restricted to one that is taken in real-time (e.g., a camera attached to or integral to the device is used to take the photo in order to establish that it is being taken in “real-time”) and/or just as it is being distributed to a system in the authentication system 100. The location photo may be used as a way to identify the location as well as a way to verify that the user attempting authentication is physically at the location. In some embodiments, the user may be presented with instructions similar to the following: “Pick an area of this location that remains unchanged for the time slot you have selected. For example, a closed cupboard, a closed door, or a bookshelf. Also, pick an area that has at least four colors in it.” In order to provide a reliable verification method, in some embodiments, the user may be prompted to use a photo that is unique to the location or that would not be an obvious photo for unauthorized intruders to use. In some embodiments, the user may be prompted to use a location photo that does not change during the location time slot and does not change during the period of time (e.g., one month, six months, one year, ten years) the location will be used for authentication. In some embodiments, since a purpose of the location photo may be user authentication, it may be advised that the user select a photo that is only known to the user, and that the user does not share that location photo with any other users.

The “photo” referred to throughout this disclosure may be a still photo, a video, or multiple still photos (e.g., a “Live Photo”, an animated GIF). While this disclosure uses the word “photo” or “location photo” to refer to the multimedia used for user validation and authentication, the photo may refer to a single still photo taken with a camera, multiple still photos chained together, a video, a still image taken from a single frame of a video, three dimensional images, holographic images, or other multimedia that provides a visual representation of the location that may be gathered by a user device.

Upon receiving the location photo submitted by the user in step 206, the application 106, in step 208, may determine if the location photo has enough colors in the image to be considered a secure location photo. In some embodiments, the authentication system 100 may determine the acceptability of the location photo using a variety of methods, including validating that the location photo includes enough colors. In some embodiments, the authentication system 100 may use an API (e.g., the ColorTag API) to determine the number of distinct colors in the location photo. For example, in a non-limiting embodiment of the present disclosure, the ColorTag API may be used to produce a list of text labels and hexadecimal RGB values that can then be used as tags for certain images or items in the image. The ColorTag API may be used to sort the tags by relevance (e.g., recognizing colors of objects in the image) or simply by weight in the image. In embodiments that use an API to determine the colors within the image, the authentication system 100 may require a number (e.g., three, four, more than five) distinct primary colors be present within the image. If the location photo is determined to not contain enough colors, the user may be prompted to resubmit a location photo.

If the location photo is determined to contain enough colors in step 208, the authentication system 100, in step 210, may generate a perceptual hash (a “pHash”) of the location photo. A pHash includes a “fingerprint” of a multimedia file that is derived from various features of its content. Various programming language libraries (e.g., pHash, Blockhash.io, Elog.io, Insight) may be used to create a perceptual hash of media files in a process such that similar files will generate similar hashes. Other libraries or methods may also be used to generate the perceptual hash. Unlike a cryptographic hash function, which relies on the avalanche effect of small changes in input leading to drastic changes in the output, pHashes are similar to one another if the features of the multimedia file are similar. pHashes are robust enough to take into account transformations in the media file (e.g., rotation, skew, contrast adjustment, and different compression/formats) while being flexible enough to distinguish between dissimilar files. The pHash algorithm may use different methods of hashing for different types of media files and may use several different hashing mechanisms for generating the pHash of images (e.g., discrete cosine transform (“DCT”) hash, radial image hash, histogram-based image hash). The output of the pHash algorithm may be a string of numbers and characters that represent the pHash of the location photo. The pHash generated in step 210 may also be associated with an index, where the index may be any value. In some embodiments, the index may be a timestamp of the time the image was taken or when the pHash was generated. The index may be used to identify the pHash generated for the location photo. After generating the pHash and index for the location photo, the location photo may be deleted so that the photo itself does not exist on any system, and only the pHash of the image may remain to identify the location photo.

Once the pHash of the location photo is generated in step 210, the authentication system 100, in step 212, may determine whether the pHash of the location photo is similar to, or matches, the pHashes of previous photos 122 used for the location. The determination of step 212 may be limited to a certain number of historical photos used for the location 122 (e.g., past two photos, past three photos, past five photos) or may use all historical photos used for the location. In order to determine whether two pHashes are similar, the authentication system 100 may use different methods of hash comparison. In some embodiments, the pHashes may be compared by determining the Hamming distance between the two pHashes.

The Hamming distance may be defined as the number of positions at which the corresponding symbols are the same. In the case of pHashes, the Hamming distance may be calculated as the number of bits that are the same between two pHashes divided by the total number of bits in the pHash. For example, in a non-limiting embodiment of the present disclosure, if two 256-bit pHashes have 20 bits that differ, the Hamming distance between those pHashes is 236/256 or 0.921875. Once the Hamming distance has been determined for a given pair of pHashes, the Hamming distance may be compared to a pre-determined threshold (e.g., 0.80, 0.84, 0.85, 0.90, 0.96) to decide if the images represented by the pHashes are similar. In some embodiments, the threshold for the Hamming distance may be dynamic based on the historical behavior of the authentication system 100 and the images analyzed by the system. If the authentication system 100 determines that the location photo is similar to a previously used photo for the same location, then the application 106 may prompt the user to resubmit a location photo. If the authentication system 100 determines that the location photo is not similar to a historical photo for the same location, the system may proceed to step 214.

In step 214, the authentication system 100 may generate dummy pHashes and dummy indexes. To combat the ability for nefarious entities to access the application 106 and directly access the pHash of the location photo, the application 106 may generate a plurality of dummy pHashes (e.g., 99 dummy pHashes, 255 dummy pHashes, 1023 dummy pHashes) which may appear to be the true location pHash. In some embodiments, the application may generate a plurality of dummy indexes associated with each of the plurality of dummy pHashes. In certain embodiments, the dummy indexes may operate similar to real indexes, where the dummy index points to its associated dummy pHash. In some embodiments, the dummy indexes may appear similar to the true index. For example, in a non-limiting embodiment for the present disclosure, when the true index is a timestamp, the dummy indexes may be generated as timestamps that occur both just before and just after the true index. For example, in a non-limiting embodiment for the present disclosure, if the true index is defined as a Unix epoch time with a value of 1519839770, then some of the dummy indexes generated may have the values 1519839768, 1519839769, 1519839771, 1519839772. In this way, an intruder into the system may not be able to easily identify which index is the true index and which pHash is the true pHash. In some embodiments, the generated dummy pHashes may have a Hamming distance below the pre-defined threshold.

In step 216, the application 106 may encrypt all the pHashes and all the indexes, and store them. The application 106 may use a pHash encryption key 120 to encrypt the true pHash and the plurality of dummy pHashes. In some embodiments, the application 106 may use an index encryption key 118 to encrypt the true index and the plurality of dummy indexes. Upon encrypting the pHashes and indexes, the application 106 may store the plurality of encrypted pHashes and indexes 112 as depicted in FIG. 1A. The pHash encryption key 120 and the index encryption key 118 may be stored by the application 106 so that only the application 106 has access to the encryption keys. The pHash encryption key 120 and the index encryption key 118 may be able to decrypt the encrypted pHashes and encrypted indexes, respectively. Upon encryption of the pHashes and indexes, all references or data related to the unencrypted pHashes and indexes, including the true pHash and true index, may be deleted so that no trace of the pHashes or indexes are left on the system that are not encrypted.

In step 218, after generating and encrypting the plurality of pHashes and indexes, the application 106 may transmit the location, location keyword, location time slot, and the encrypted true index to the authentication server 102. It is important to note that in step 218, the application 106 may not send the encrypted or unencrypted true pHash of the location photo to the authentication server 102. In some embodiments, an advantage of the present disclosure may be increased security stemming from the fact that the true pHash may never be transmitted by the application 106 and the true pHash may not be stored in an unencrypted format.

After receiving the location, location keyword, location time slot, and the encrypted true index, the authentication server 102 may determine whether the location is being added for the first time. The authentication server 102 may determine whether the location is being added for the first time by comparing the location keyword to location keywords already stored on the authentication server 102. In some embodiments, the authentication server 102 may determine whether the location is being added for the first time by comparing the coordinates associated with the location to previously stored location coordinates. In some embodiments, the authentication server 102 may skip step 220 completely and always execute step 222. In some embodiments, the authentication server 102, in response to determining that the location is not being added for the first time, may store the new location information and end the user location creation 200.

The authentication server 102, in response to determining that the location is being added for the first time, may store the new location information, generate a provision for generating a time-based one-time password (“TOTP”), and send the TOTP provision to the application 106. Upon receiving the TOTP provision, the application 106 may store the TOTP provision 124 locally to use later to authenticate with the authentication server 102.

The TOTP provision is a key that is generated and may uniquely identify the user and the user device. In a particular embodiment, the TOTP provision is a hashed shared secret key. In other embodiments, the TOTP provision can be any generated string or value that is unique and can be used by the authentication server 102 to associate a TOTP with the application 106 and a location. A TOTP may be generated by combining the TOTP provision, the current time, and a time interval using various methods. First, the current timestamp may be converted into an integer time counter by subtracting the current timestamp from a known point in time (e.g., Unix epoch) and dividing the result by a time interval and rounding down. The time interval may be determined by the authentication server 102 and provided as part of the TOTP provision to the application 106. The time interval represents a period of time during which a given TOTP is valid. After the time interval has passed, the integer time counter increments. Thus, the time interval is often set for shorter time periods. In a particular embodiment, the time interval may be set to thirty seconds. In other embodiments, the time interval may be set anywhere from a few minutes (e.g., 2 minutes, 5 minutes) to a few seconds. The TOTP provision may be limited with respect to time (e.g., days, weeks, months) or it may be valid indefinitely. While the TOTP provision may last for a longer period of time, the TOTP generated using the TOTP provision will only be valid for a shorter period of time (e.g., seconds or minutes) based on the time interval. For example, in a particular embodiment, the TOTP may be valid for one minute or less (e.g., thirty seconds). The short lifespan of the generated password is one advantage of using a TOTP authentication system, providing additional security over traditional authentication mechanisms.

In another embodiment, the TOTP provision may be used along with the integer time counter to generate the TOTP. In a particular embodiment, the TOTP provision is combined with the integer time counter using a cryptographic secured hash function (e.g., SHA-1) to generate a TOTP. The secured hash function may take the integer time counter, concatenate it with the secured hash of the TOTP provision XOR with a predetermined value. This result can be concatenated again with the TOTP provision XOR with a different predetermined value, and hashed again to generate the TOTP. In order to decode the TOTP, the recipient may use the TOTP provision along with the secured hash function to decrypt the layers until all that is left is the integer time counter. In other embodiments, decoding the TOTP may not be possible, and instead the recipient may use the TOTP provision to regenerate a TOTP value for the present time interval and compare the resulting value to the received TOTP.

FIG. 3 is a flowchart of operations and information flows for user authentication 300 of a non-limiting embodiment of the present disclosure. The user authentication flow 300 may allow the authentication system 100 to authenticate users using a location and time-based photo authentication process. The user authentication flow 300 may occur after the user location creation flow 200 has been completed at least once, meaning that at least one location has been successfully registered with the authentication server 102.

The application 106, in step 302, may prompt the user to enter a location keyword. In some embodiments, the location keyword may be chosen from a list of valid locations. In other embodiments, the user may have to enter the location keyword with no options. In embodiments where the user is prompted to enter a location keyword with no indication of which location keywords are valid, the authentication system 100 may provide additional security when a user selects a non-obvious location keyword and reduce the risk of an unauthorized user guessing the location keyword. In step 302, the application 106 may also obtain the current location coordinates of the user and the current time when the user submits the location keyword. This additional information may be transmitted to the authentication server 102 in step 304.

In step 304, the application 106 may transmit the current location, location keyword, and current time to the authentication server 102. Since the location coordinates, location keyword, and location time slot may already be stored on the authentication server 102, the authentication server 102 has the ability to determine, in step 306 whether the location is valid for that user. In some embodiments, the process of step 306 may be conducted by the application itself. The authentication server 102, or the application 106, may compare the location keyword to location keywords associated with the user requesting authentication to determine if the location keywords match. If the location keywords match, the authentication server 102, or the application 106, may then compare the location coordinates to the valid location coordinates associated with the location keyword to validate that the location coordinates match. In some embodiments, the stored location coordinates may indicate a range of coordinates, or a threshold factor, which indicates how close to the stored location coordinates the submitted location coordinates must be to constitute a match. In addition to validating the location keyword and location coordinates, the authentication server 102, or the application 106, at step 307 may also confirm that the current time transmitted by the application 106 falls within the location time slot associated with the location keyword on the authentication server 102.

If any of the location coordinates, location keyword, current time or location time slot do not match the information transmitted by the application 106, then the authentication server 102 will fail to authenticate the user in step 308. In some embodiments, when the user fails to authenticate, the authentication server 102 may send a message to the application 106 indicating that the authentication has failed. In some embodiments, the authentication failure message may take the format of an expected authentication success message, such as sending a dummy encrypted index.

If the authentication server 102, in step 306, determines that the location information is valid, the authentication server 102 may send a message to the application 106 to prompt the user, in step 310, for a location photo. The prompt to the user for a location photo may restrict the user from submitting an existing photo. The application 106 may restrict the user through locks or checks available to applications within a specific mobile operating system, or may perform certain checks itself to validate that the user did not submit a pre-existing photo. A pre-existing photo, in some embodiments, may refer to photos taken previously (e.g., more than 3 minutes ago, more than 5 minutes ago, more than 15 minutes ago, more than an hour ago, more than a day ago) by the device. In some embodiments, the application 106 may check the timestamp of the photo and the coordinates associated with the photo and compare them to the current time and current coordinates to make sure the photo was just taken. The application 106, in some embodiments, may actually check through the user's mobile device storage (e.g., camera roll or photo roll) to make sure the photo taken does not exactly match another photo previously taken by the user.

Upon receiving the location photo from the user, the application 106, in step 312, may transmit a request for the encrypted index associated with the true pHash of the location photo to the authentication server 102. In some embodiments, the request for the encrypted index may include the coordinates and timestamp that the photo was taken. In those embodiments, the authentication server 102 may again validate that the submitted coordinates and timestamp are valid for the location coordinates and location time slot stored on the authentication server 102. In some embodiments, the location validation of step 306 may occur after the user submits a photo in step 310, rather than sending the location information first then requesting the encrypted timestamp in a separate step. In some embodiments, the photo submitted by the user for authentication may never be transmitted to the authentication server 102 for security purposes. If the photo submitted by the user is never transmitted away from the application 106, there may be a lower risk for nefarious entities to intercept the location photo necessary for user authentication. The authentication server 102, in response to receiving the request for the encrypted timestamp from the application 106, may look up the encrypted index, stored on the authentication server 102, associated with the location keyword.

In step 314, the authentication server 102 may send the encrypted true index to the application 106. Upon receiving the encrypted true index from the authentication server 102, the application 106 may match the received encrypted true index to the stored encrypted true index 114. In some embodiments, the application 106 may then decrypt the encrypted true index using the index encryption key 118, as shown in step 316. The decrypted true index may then be used by the application 106 to find the stored encrypted true pHash 116.

In step 318, after finding the stored true pHash of the location photo, the application 106 may decrypt the true pHash using the pHash encryption key 120. In step 318, or in an earlier or later step, the application 106 may also generate the pHash of the user submitted location photo of step 310. The pHash generated by the application 106 of the user submitted location photo may be generated using the same perceptual hashing mechanism used to generate the true pHash of the location photo of step 210.

Once the application 106 has decrypted the stored true pHash and generated the pHash of the user submitted photo, the application 106 may determine whether the stored true pHash matches the pHash of the user submitted photo. The determination of whether two pHashes match in step 320, similar to step 212, may calculate the Hamming distance and use the distance in combination with a distance threshold to determine whether the pHashes are similar. If the pHashes are not similar enough, the application may return to step 310 and request that the user resubmit a location photo. In some embodiments, the user may not have the opportunity to submit another photo, and the application 106 proceeds to step 308 and fails authentication. In other embodiments, the application 106 may give the user additional chances (e.g., two more chances, four more chances) to submit a valid location photo. In those embodiments where the user is given additional chances to submit a location photo for authentication, the application 106 may proceed to step 308 after the additional chances have been attempted by the user, but authentication cannot be granted.

In embodiments where the authentication fails in step 320, the application 106 may send a message back to the authentication server 102 providing a dummy TOTP and dummy new encrypted index so that unauthorized entities that intercept the authentication messages may not be able to determine if the request to the authentication server 102 is valid. In some embodiments, if the authentication fails in step 320 and the application 106 sends a dummy TOTP and a dummy new encrypted index to the authentication server 102, the authentication server 102 may maintain the number of failures by a user. If the user fails authentication multiple times (e.g., one failure, three failures, five failures) for a user or a location, either in succession or in total, the authentication server 102 may take actions to disable the user from future authentication. In the embodiments where the user fails authentication multiple times, the authentication server 102 may require the user to re-register, may require the user to re-register the particular location, or may require other authentication methods before enabling the user to authenticate again. If the pHashes are determined, in step 320, to be similar, then the application may proceed to step 322.

In step 322, the application 106 may randomly modify all the indexes associated with both the true and dummy pHashes. The application 106 may modify the indexes so that the indexes may not be reused from previous authentication attempts. The modification of the indexes, in some non-limiting embodiments of the present disclosure, may reduce the risk of intrusion by unauthorized entities who intercept the encrypted true index by changing the encrypted true index after each successful authentication attempt. Since the authentication server 102 also may not know what the location photo or true pHash of the location photo are, the ability for unauthorized intrusion may be significantly reduced. The modification of the indexes may follow the method described in step 214 for generating dummy indexes. Upon modifying the indexes, the application 106 may use the index encryption key 118 to encrypt and store the newly generated indexes.

In step 324, the application 106 may use the TOTP provision obtained from the authentication server 102, in step 222, to generate a time-based one-time password. Upon generating the TOTP, the application 106, in step 326, may transmit the generated TOTP and the new encrypted true index to the authentication server 102.

In step 328, the authentication server 102 may determine whether the TOTP received from the application 106 is a valid TOTP. The authentication server 102 may validate the TOTP by generating a TOTP using the TOTP provision 110 stored on the authentication server 102 and compare the received TOTP with the generated TOTP. If the two TOTPs match, then the authentication server 102 may consider the TOTP to be valid. In some embodiments, the authentication server 102 may use any other method available to validate the TOTP (e.g., decrypting the TOTP). If the authentication server 102 determines that the TOTP is not valid, the authentication server 102 may decline to authenticate the user through step 308. If the TOTP is determined to be valid, then the authentication server 102 may proceed to step 330.

In step 330, the authentication server 102 may store the new encrypted true index 108 received from the application 106. The new encrypted true index 108 may replace the previously stored encrypted true index, since the previously stored encrypted true index may no longer be valid. After storing the new encrypted true index 108, the authentication server 102 may send an authentication success message to the application 106. Upon receiving the authentication success message, the application 106 may authorize the user.

The flowchart and block diagrams in the figures illustrate examples of the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving a first request for authentication from a user, the first request including a current location, a current location keyword, a current timestamp, and a photo representing the current location;
generating a pHash of the photo representing the current location;
transmitting a second request for an encrypted true index from a server;
receiving the encrypted true index from the server;
interrogating a plurality of pHashes to identify a true pHash that corresponds to the encrypted true index;
wherein the plurality of pHashes includes the true pHash and a plurality of dummy pHashes, each of the plurality of dummy pHashes being associated with a respective dummy index; and
comparing the pHash of the photo representing the current location with the true pHash to determine whether to authenticate the user.

2. The method of claim 1, further comprising:
determining whether the current location keyword matches a stored location keyword;
determining whether the current location matches a stored location associated with the stored location keyword;
determining whether the current timestamp falls within a stored time slot associated with the stored location keyword; and
wherein generating the pHash of the photo representing the current location comprises generating the pHash of the photo representing the current location in response to determining that the current location keyword matches the stored location keyword, determining that the current location matches the stored location associated with the stored location keyword, and determining that the current timestamp falls within the stored time slot associated with the stored location keyword.

3. The method of claim 1, further comprising:
determining whether the pHash of the photo representing the current location is a match to the true pHash; and
in response to determining that the pHash of the photo representing the current location is a match to the true pHash, determining to authenticate the user.

4. The method of claim 1, further comprising:
determining whether the photo representing the current location comprises a pre-existing photo; and
denying the first request for authentication from the user in response to determining that the photo representing the current location comprises a pre-existing photo.

5. The method of claim 1, wherein comparing the pHash of the photo representing the current location with the true pHash comprises determining whether a Hamming distance between the pHash of the photo representing the current location and the true pHash is below a threshold.

6. The method of claim 1, further comprising:
associating a new true index with the true pHash;
encrypting the new true index with a secret key;
modifying each of the plurality of dummy indexes;
individually encrypting each of the plurality of dummy indexes with the secret key;
generating a time-based one-time password using a time-based one-time password provision;
transmitting the time-based one-time password and the new true index to the server; and
receiving an authentication confirmation from the server.

7. The method of claim 1, further comprising:
receiving a selected location, a selected location keyword, a selected time slot, and a photo representing the selected location;
generating a pHash of the photo representing the selected location;
designating the generated pHash of the photo representing the selected location as the true pHash;
associating the true pHash with the true index;
generating a plurality of dummy pHashes;
associating each of the plurality of dummy pHashes with a respective dummy index;
encrypting the true pHash with a first secret key;
individually encrypting each of the plurality of dummy pHashes with the first secret key;
encrypting the true index with a second secret key;
individually encrypting each of the plurality of dummy indexes with the second secret key; and
transmitting the encrypted true index to the server.

8. The method of claim 7, further comprising:
determining whether the photo representing the selected location comprises at least four colors; and
wherein generating a pHash of the photo representing the selected location comprises generating a pHash of the photo representing the selected location in response to determining that the photo representing the selected location comprises at least four colors.

9. The method of claim 7, further comprising:
determining whether the selected location is unique among a plurality of previously selected locations; and
wherein generating a pHash of the photo representing the selected location comprises generating a pHash of the photo representing the selected location in response to determining that the selected location is unique among the plurality of previously selected locations.

10. The method of claim 7, further comprising:
comparing the pHash of the photo representing the selected location to previously used pHashes of photos representing the selected location; and
wherein designating the generated pHash of the photo representing the selected location as the true pHash comprises designating the generated pHash of the photo representing the selected location as the true pHash in response to determining that the pHash of the photo representing the selected location is distinct from any of the previously used pHashes of photos representing the selected location.

11. The method of claim 7, wherein comparing the pHash of the photo representing the selected location to previously used pHashes of photos representing the selected location comprises determining whether a Hamming distance between the pHash of the photo representing the selected location and each of the previously used pHashes of photos representing the selected location is below a first threshold.

12. A computer configured to access a storage device, the computer comprising:
a processor; and
a non-transitory, computer-readable storage medium storing computer-readable instructions that when executed by the processor cause the computer to perform:
receiving a first request for authentication from a user, the first request including a current location, a current location keyword, a current timestamp, and a photo representing the current location;
generating a pHash of the photo representing the current location;
transmitting a second request for an encrypted true index from a server;
receiving the encrypted true index from the server;
interrogating a plurality of pHashes to identify a true pHash that corresponds to the encrypted true index;
wherein the plurality of pHashes includes the true pHash and a plurality of dummy pHashes, each of the plurality of dummy pHashes being associated with a respective dummy index; and
comparing the pHash of the photo representing the current location with the true pHash to determine whether to authenticate the user, wherein comparing the pHash of the photo representing the current location with the true pHash comprises determining whether a Hamming distance between the pHash of the photo representing the current location and the true pHash is below a threshold.

13. The computer of claim 12, wherein the computer-readable instructions further cause the computer to perform:
determining whether the current location keyword matches a stored location keyword;
determining whether the current location matches a stored location associated with the stored location keyword;
determining whether the current timestamp falls within a stored time slot associated with the stored location keyword; and
wherein generating the pHash of the photo representing the current location comprises generating the pHash of the photo representing the current location in response to determining that the current location keyword matches the stored location keyword, determining that the current location matches the stored location associated with the stored location keyword, and determining that the current timestamp falls within the stored time slot associated with the stored location keyword.

14. The computer of claim 12, wherein the computer-readable instructions further cause the computer to perform:
determining whether the pHash of the photo representing the current location is a match to the true pHash; and
in response to determining that the pHash of the photo representing the current location is a match to the true pHash, determining to authenticate the user.

15. The computer of claim 12, wherein the computer-readable instructions further cause the computer to perform:
determining whether the photo representing the current location comprises a pre-existing photo; and
denying the first request for authentication from the user in response to determining that the photo representing the current location comprises a pre-existing photo.

16. The computer of claim 12, wherein the computer-readable instructions further cause the computer to perform:
associating a new true index with the true pHash;
encrypting the new true index with a secret key;
modifying each of the plurality of dummy indexes;
individually encrypting each of the plurality of dummy indexes with the secret key;
generating a time-based one-time password using a time-based one-time password provision;
transmitting the time-based one-time password and the new true index to the server; and
receiving an authentication confirmation from the server.

17. The computer of claim 12, wherein the computer-readable instructions further cause the computer to perform:
receiving a selected location, a selected location keyword, a selected time slot, and a photo representing the selected location;
generating a pHash of the photo representing the selected location;
designating the generated pHash of the photo representing the selected location as the true pHash;
associating the true pHash with the true index;
generating a plurality of dummy pHashes;
associating each of the plurality of dummy pHashes with a respective dummy index;
encrypting the true pHash with a first secret key;
individually encrypting each of the plurality of dummy pHashes with the first secret key;
encrypting the true index with a second secret key;
individually encrypting each of the plurality of dummy indexes with the second secret key; and
transmitting the encrypted true index to the server.

18. The computer of claim 17, wherein the computer-readable instructions further cause the computer to perform:
determining whether the photo representing the selected location comprises at least four colors;
determining whether the selected location is unique among a plurality of previously selected locations; and
wherein generating a pHash of the photo representing the selected location comprises generating a pHash of the photo representing the selected location in response to determining that the photo representing the selected location comprises at least four colors and determining that the selected location is unique among the plurality of previously selected locations.

19. The computer of claim 17, wherein the computer-readable instructions further cause the computer to perform:
comparing the pHash of the photo representing the selected location to previously used pHashes of photos representing the selected location;
wherein comparing the pHash of the photo representing the selected location to previously used pHashes of photos representing the selected location comprises determining whether a Hamming distance between the pHash of the photo representing the selected location and each of the previously used pHashes of photos representing the selected location is below a first threshold; and
wherein designating the generated pHash of the photo representing the selected location as the true pHash comprises designating the generated pHash of the photo representing the selected location as the true pHash in response to determining that the pHash of the photo representing the selected location is distinct from any of the previously used pHashes of photos representing the selected location.

20. A computer program product comprising:
a computer-readable storage medium having computer-readable program code embodied therewith, the computer-readable program code comprising:
computer-readable program code configured to receive a first request for authentication from a user, the first request including a current location, a current location keyword, a current timestamp, and a photo representing the current location;
computer-readable program code configured to determine whether the current location keyword matches a stored location keyword;
computer-readable program code configured to determine whether the current location matches a stored location associated with the stored location keyword;
computer-readable program code configured to determine whether the current timestamp falls within a stored time slot associated with the stored location keyword;
computer-readable program code configured to generate a pHash of the photo representing the current location, wherein generating the pHash of the photo representing the current location comprises generating the pHash of the photo representing the current location in response to determining that the current location keyword matches the stored location keyword, determining that the current location matches the stored location associated with the stored location keyword, and determining that the current timestamp falls within the stored time slot associated with the stored location keyword.
computer-readable program code configured to transmit a second request for an encrypted true index from a server;
computer-readable program code configured to receive the encrypted true index from the server;
computer-readable program code configured to interrogate a plurality of pHashes to identify a true pHash that corresponds to the encrypted true index;
wherein the plurality of pHashes includes the true pHash and a plurality of dummy pHashes, each of the plurality of dummy pHashes being associated with a respective dummy index;
computer-readable program code configured to compare the pHash of the photo representing the current location with the true pHash to determine whether to authenticate the user;
wherein comparing the pHash of the photo representing the current location with the true pHash comprises computer-readable program code configured to determine whether a Hamming distance between the pHash of the photo representing the current location and the true pHash is below a threshold;
computer-readable program code configured to determine whether the pHash of the photo representing the current location is a match to the true pHash;
computer-readable program code configured to determine to authenticate the user, in response to determining that the pHash of the photo representing the current location is a match to the true pHash.
